(19) United States
(12) Patent Application Publication
(10) Pub. No.: US 2024/0412132 A1
(43) Pub. Date: Dec. 12, 2024

(54) MACHINE LEARNING-BASED PROJECT EVALUATION, PREDICTION, AND RECOMMENDATION SYSTEM

(71) Applicant: Verizon Patent and Licensing Inc., Basking Ridge, NJ (US)

(72) Inventors: Qiao Yu, Ashburn, VA (US); John S. Mccormick, Cary, NC (US); Amritham N. Koduvayur, Tampa, FL (US)

(21) Appl. No.: 18/332,174

(22) Filed: Jun. 9, 2023

(51) Int. Cl. G06Q 10/0631

(52) U.S. Cl. CPC G06Q 10/06313

(57) ABSTRACT

A method, a device, and a non-transitory storage medium are described in which a machine learning-based project evaluation, prediction, and recommendation service is provided. The service may include obtaining performance data pertaining to key performance indicators (KPIs) and groups of a project and calculating affinity propagation using the performance data. The service may further include calculating prospective target KPI values for groups that may have deficient current KPI values based on similar performance data associated with other groups. The service may also include calculating time periods allotted to attain the prospective target KPI values.

### BACKGROUND

Development and design of machine learning systems continue to evolve as well as their use in a wide variety of fields and applications.

### BRIEF DESCRIPTION OF THE DRAWINGS

FIG. 1 is a diagram illustrating an exemplary environment in which an exemplary embodiment of a machine learning-based project evaluation, prediction, and recommendation service may be implemented;

FIGS. 2A-2F are diagrams illustrating an exemplary process of an exemplary embodiment of the machine learning-based project evaluation, prediction, and recommendation service;

FIG. 3 is a diagram illustrating exemplary components of a device that may correspond to one or more of the devices illustrated and described herein; and

FIG. 4 is a flow diagram illustrating an exemplary process of an exemplary embodiment of a machine learning-based project evaluation, prediction, and recommendation service.

### DETAILED DESCRIPTION

The following detailed description refers to the accompanying drawings. The same reference numbers in different drawings may identify the same or similar elements. Also, the following detailed description does not limit the invention.

Key performance indicators (KPIs) may be measured over time to determine the quality of results over various stages during a project. For example, in a workplace environment, a team or an organization may be assigned a project to accomplish a particular goal, such as building a device, designing a software package, or upgrading or improving a current product. Typically, various teams may be assigned different sub-tasks to complete the project. However, a system that may assist in evaluating various metrics and current project results may be unable to evaluate prospective project results and/or identify achievable improvements of KPIs that may currently contribute to deficient performance. Consequently, the system may be unable to accurately provide recommendations that assist in remedying and improving project results.

According to exemplary embodiments, a machine learning-based project evaluation, prediction, and recommendation service is described. According to various exemplary embodiments, the machine learning-based project evaluation, prediction, and recommendation service may be implemented in systems that may facilitate the management and evaluation of collaborative tasks and/or projects. For example, the projects may relate to the designing, developing, upgrading, and/or versioning of software, devices, and/or other types of products. By way of further example, the machine learning-based project evaluation, prediction, and recommendation service may be used to manage and evaluate the progression of a project pertaining to software maturity.

According to an exemplary embodiment, the machine learning-based project evaluation, prediction, and recommendation service may include an evaluation service that identifies and determines current results of a project or similar undertaking based on KPIs and performance data. For example, the performance data may be indicative of a state of project output or result (e.g., initial, intermediary, final, etc.) over a time period in view of the KPIs. According to an exemplary embodiment, the performance data of the project may be associated with human resources (e.g., multiple teams or groups (referred to as “groups”)) and non-human resources (e.g., devices, tools, etc.).

According to an exemplary embodiment, the evaluation service may calculate current KPI values of the groups based on the performance data of a time period associated with each group and the KPIs. According to an exemplary embodiment, the evaluation service may fuzzy the performance data based on time as a preparatory step to using an affinity propagation-based clustering method, as described herein. For example, the evaluation service may calculate availability, responsibility, and criterion data, based on fuzzy similarity data, as described herein. According to an exemplary embodiment, the evaluation service may identify similar and/or dissimilar current performance data and/or current KPI values amongst the groups.

According to an exemplary embodiment, the machine learning-based project evaluation, prediction, and recommendation service may include a prediction service that may forecast performance data and/or KPI values attributable to each group. According to an exemplary embodiment, the prediction service may calculate a target KPI value for a group based on current and/or historical performance data and/or KPI values of the group and current and/or historical performance data and/or KPI values relative to one or more other groups, as described herein. According to an exemplary embodiment, the prediction service may identify a degree of similarity and/or dissimilarity of the performance data, a category of a KPI, a KPI, and/or the KPI values between groups as a basis for calculating the target KPI value, as described herein. The target KPI value may relate to a KPI where a current KPI value is deficient but improvement is achievable.

According to an exemplary embodiment, the machine learning-based project evaluation, prediction, and recommendation service may include a recommendation service that may calculate a time period for the group to satisfy the target KPI value. According to an exemplary embodiment, the recommendation service may provide recommendations regarding achievement of the target KPI value. For example, the recommendation service may indicate certain resources be made available, changed, and/or used.

In view of the foregoing, the machine learning-based project evaluation, prediction, and recommendation service may improve the assessment of the current and prospective state of a project over time (e.g., from start to completion). The machine learning-based project evaluation, prediction, and recommendation service may enable a user to optimize project results based on the generation of target KPI values and time periods during which the target KPI values may be achieved in relation to certain KPIs and current KPI values that may be identified as deficient or likely to be able to be improved. The machine learning-based project evaluation, prediction, and recommendation service may calculate more accurate, realistic, and achievable targets of KPI values and time periods ascribed to a group compared to assessments and determination made by project personnel. The machine learning-based project evaluation, prediction, and recommendation service may also provide recommendations that facilitate the attainment of the target KPI values during an allotted time period, as well as improve the evaluation, prediction, and recommendation services over time based on the reassessment of performance data and historical evaluations, predictions and recommendations.

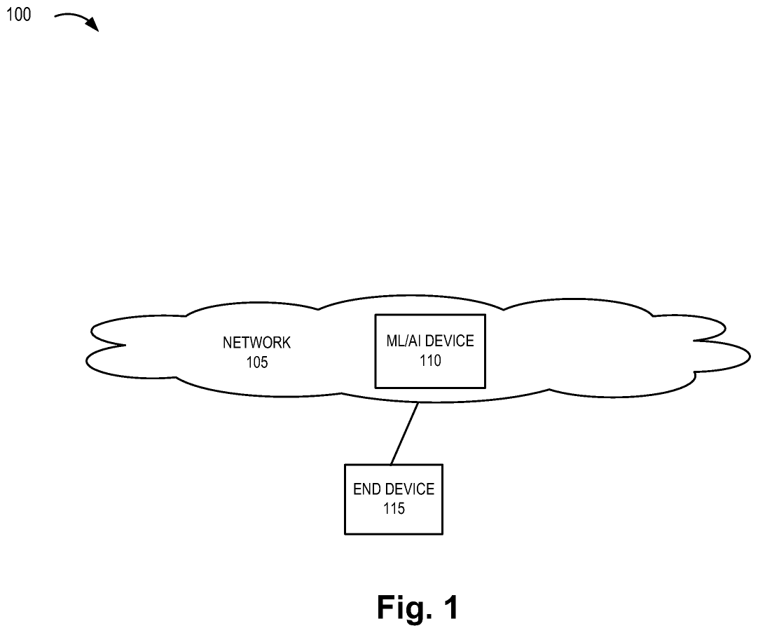

FIG. 1 is a diagram illustrating an exemplary environment 100 in which an exemplary embodiment of machine learning-based project evaluation, prediction, and recommendation service may be implemented. As illustrated, environment 100 includes a network 105. Network 105 may include a machine learning and/or artificial intelligence (ML/AI) device 110 that provides an exemplary embodiment of the machine learning-based project evaluation, prediction, and recommendation service, as described herein. Environment 100 may further include an end device 115.

According to other exemplary embodiments, environment 100 may not include network 105. According to another exemplary embodiment, end device 115 may include ML/AI device 110, in whole or in part. For example, ML/AI device 110 and end device 115 may collaboratively process and provide an exemplary embodiment of the machine learning-based project evaluation, prediction, and recommendation service. According to another example, ML/AI device 110 may provide an exemplary embodiment of the machine learning-based project evaluation, prediction, and recommendation service, which may be accessed and used by a user via end device 115.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture. The number, the type, and the arrangement of network devices and end device 115 are exemplary.

Environment 100 includes communication links between ML/AI device 110 and end device 115. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication.

Network 105 may include one or multiple networks of one or multiple technologies. For example, network 105 may include a radio access network (RAN), a core network, a local area network (LAN), a wide area network (WAN), a public network, a private network, an enterprise network, the Internet, an application service layer network (e.g., a cloud network, a multi-access edge computing (MEC) network, etc.), and/or another type of network that may provide access and use of machine learning-based project evaluation, prediction, and recommendation service (e.g., ML/AI device 110) by end device 115 and a user (not illustrated).

ML/AI device 110 may include logic that provides one or multiple operations, in whole or in part, of an exemplary embodiment of the machine learning-based project evaluation, prediction, and recommendation service, as described herein. According to an exemplary embodiment, ML/AI device 110 may include logic that creates, trains, re-trains, tunes, and/or updates a model (e.g., an AI model, an ML model, a learning-based model, a custom model, a prediction model, etc.) using performance data (e.g., historical, current, prospective, etc.), KPIs, KPI values (e.g., historical, current, prospective, etc.) and an ML algorithm, an AI algorithm, a deep learning algorithm, or another type of learning algorithm, as described herein. According to various exemplary implementations, the learning algorithm may include a supervised learning algorithm, an unsupervised learning algorithm, and/or a reinforcement learning algorithm. ML/AI device 110 may include logic that includes predictive analytics. For example, ML/AI device 110 may include a model that may be implemented as a Support Vector Machine, a Decision Tree, a Neural Network, Naïve Bayes, Random Forest, another type of learning-based algorithm, and/or a non-learning-based algorithm/rule-based logic.

According to an exemplary embodiment, ML/AI device 110 may include logic that provides an evaluation service, as described herein. For example, the evaluation service may identify and determine current results of a task or portion of the project and/or the overall project based on KPIs and performance data. For example, the performance data may be indicative of the state of project output over a time period in view of a configured set of KPIs. According to an exemplary embodiment, the evaluation service may calculate current KPI values associated with KPIs that may be attributable to groups associated with a project based on the performance data of a time period associated with each group and the KPIs.

According to an exemplary embodiment, the evaluation service may fuzzy performance data values based on time, as described herein, to generate fuzzy similarity performance data associated with the groups. The generation of the fuzzy similarity performance data may include the use of a historical fuzzy value, as described herein. The evaluation service may calculate availability, responsibility, and criterion data, based on the fuzzy similarity performance data. The evaluation service may perform clustering of the data. For example, the evaluation service may identify similar and/or dissimilar current performance data and/or current KPI values amongst the groups.

ML/AI device 110 may include a prediction service that may calculate prospective performance data and/or target KPI values of the group. ML/AI device 110 may identify current KPI value deficiencies associated with one or multiple groups. According to various exemplary embodiments, ML/AI device 110 may identify a deficient KPI value of a group based on comparison with a threshold KPI value. Additionally, or alternatively, ML/AI device 110 may identify a deficient KPI value of the group based on a corresponding KPI value associated with another similar group. For example, the other similar group may have a KPI value indicative of better performance (e.g., a greater KPI value relative to the deficient KPI value) for the KPI of relevance.

The prediction service of ML/A device 110 may calculate a target KPI value for the deficient group. For example, ML/AI device 110 may evaluate and select from the performance data of a cluster, a KPI value associated with another similar group. For example, the KPI value of the other group may be proximate but better in value relative to the deficient KPI value. The performance data of the other group may be clustered in the same cluster as the deficient group and consequently have similarity in performance data and/or a current KPI value of relevance. Based on the KPI value of the similar group, the prediction service may calculate a target KPI value for the deficient group, as described herein.

The prediction service of ML/A device 110 may include logic that provides a recommendation service that may calculate the time period for the group to satisfy the target KPI value. According to various exemplary embodiments, the time period may be calculated based on various factors, which may or may not be group and/or KPI specific. For example, ML/AI device 110 may calculate the time period based on historical performance data associated with the group, historical time periods recommended for other groups of the same or similar KPIs, difference KPI values between current and target KPI values, and/or other information of relevance that may be a consideration in determining the time period during which the target KPI value may be attained. The recommendation service may also provide a recommendation regarding achievement of the target KPI value within the allotted time period. For example, the recommendation service may indicate certain resources be made available or changed. The recommendation service may generate the recommendation based on current project resources, the KPI, and resources applicable to the KPI.

ML/AI device 110 may include logic that provides a user interface (e.g., graphical user interface (GUI)) that enables a user to view the performance data of the group, current KPI values, target KPI values, historical data, and the like in one or multiple formats (e.g., charts, graphs, etc.) and assist in the management of the project regarding performance output and results associated with a task of the project and/or the overall project.

End device 115 may be implemented as a computer, such as a desktop, a laptop, a terminal, or the like, for example. According to some exemplary embodiments, end device 115 may include a client that may communicatively couple end device 115 to ML/AI device 110. End device 115 may include logic that provides one or multiple operations, in whole or in part, of an exemplary embodiment of the machine learning-based project evaluation, prediction, and recommendation service, as described herein. In this regard, according to some exemplary embodiments, the machine learning-based project evaluation, prediction, and recommendation service may be cooperatively implemented by end device 115 and ML/AI device 110. According to other exemplary embodiments, the machine learning-based project evaluation, prediction, and recommendation service may be implemented by only end device 115 or only ML/AI device 110. According to such exemplary embodiments, environment 100 may not include end device 115 or ML/AI device 110.

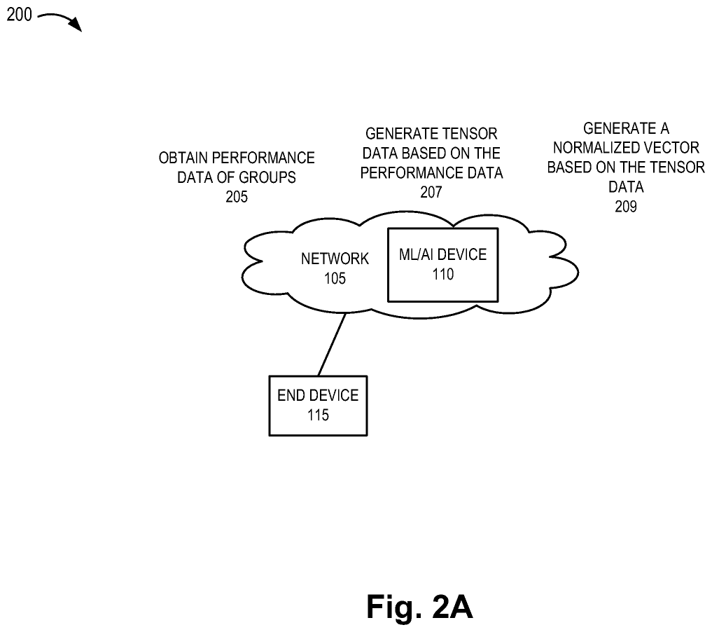

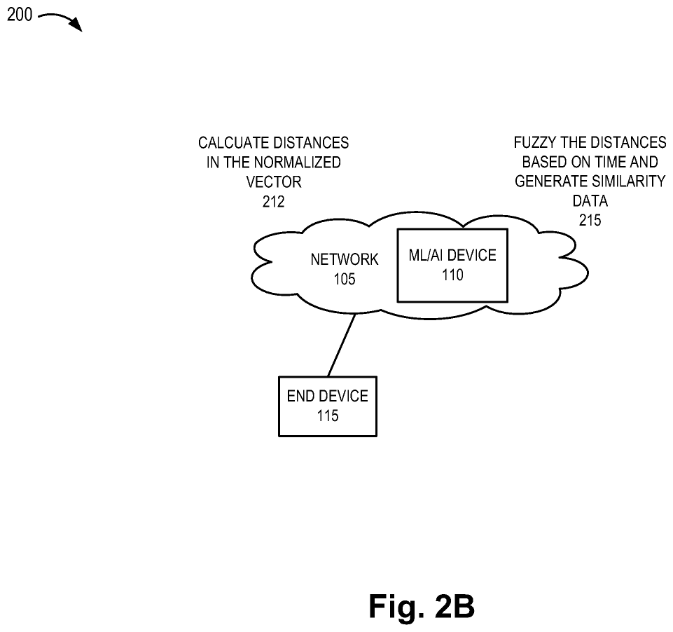

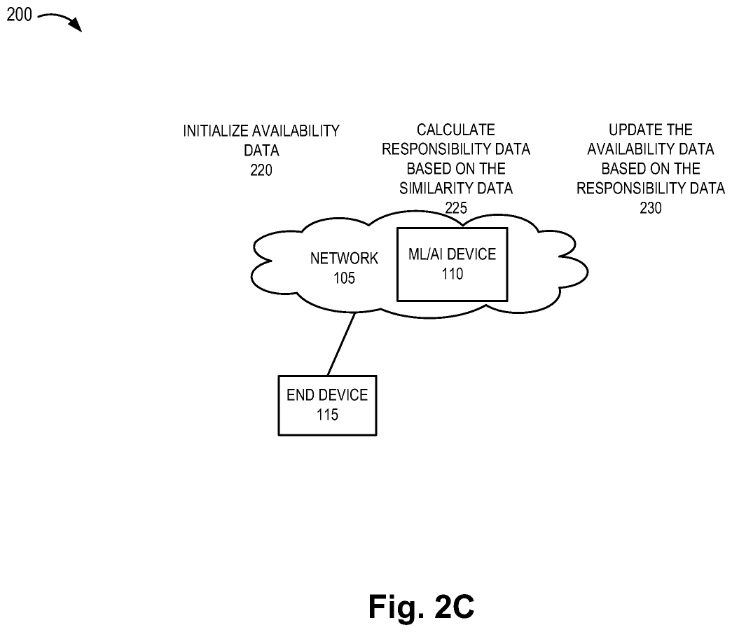

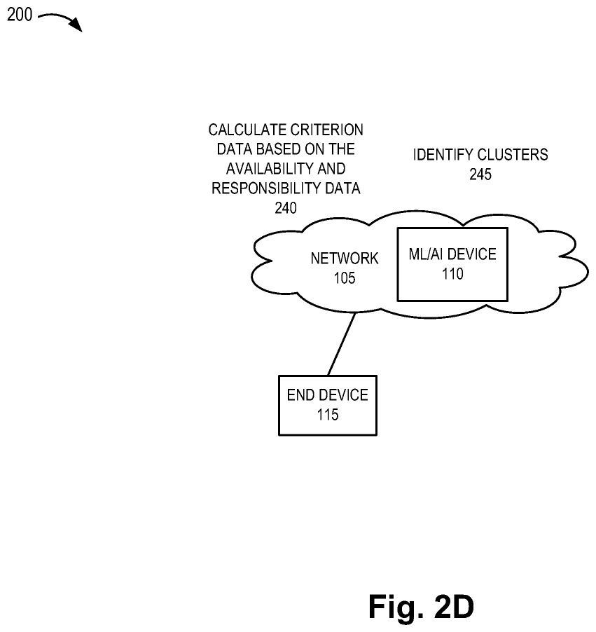

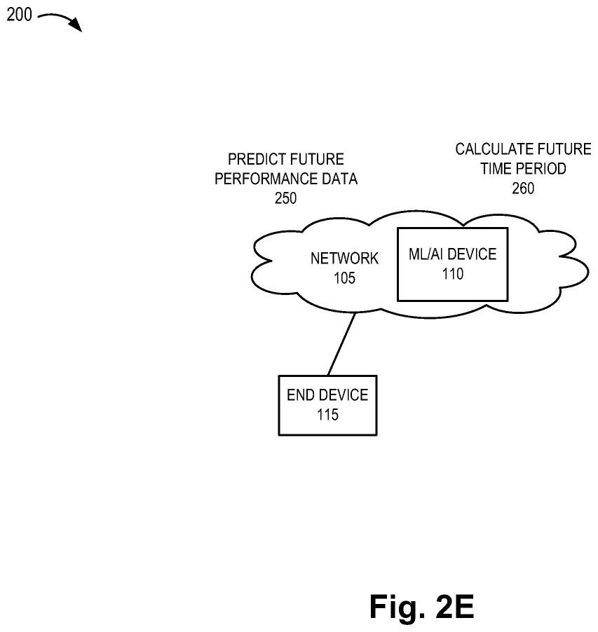

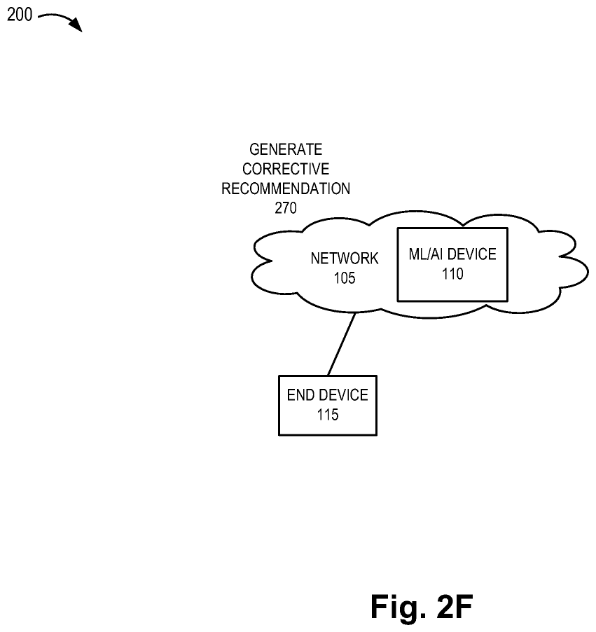

FIGS. 2A-2F are diagrams illustrating an exemplary process 200 of an exemplary embodiment of the machine learning-based project evaluation, prediction, and recommendation service. According to this exemplary embodiment, process 200 may be performed by ML/AI device 110. According to this example, the machine learning-based project evaluation, prediction, and recommendation service may be used in relation to an organization that includes multiple groups. Each group may be assigned different tasks, which may and/or may not interrelate, and which contribute to an overall goal of a project or other type of undertaking associated with the organization.

For purpose of description and example, process 200 may relate to a software maturity project and KPIs pertaining to an engineering environment within which software may be designed, developed, upgraded, and/or versioned, such as a source code repository or the like. According to this example, the exemplary KPIs may relate to various facets of the resources used. For example, the KPIs may include KPIs relating to different pipelines and criteria, such as automation, repositories built using pipelines, adherence to system repositories using specified branch names, and pipelines related to various testing (e.g., development integration test (DIT), system integration test (SIT), user acceptance test (UAT), production like environment (PLE), production, etc.); rolling update deployment methodology; software versioning (e.g., automated or not); software stack agnosticism (e.g., software languages used, databases used, operating systems used, web servers used, middleware used, use of certain business intelligence tools, etc.); unit testing; code coverage; code review (e.g., feature traceability, frequency of peer review, pair programming adoption, etc.); management of requests (e.g., requests for new development work or the like) and an associated repository; approval rules to automatically add code reviewers to new (merge) requests; risk and security related criteria; logging data collection; tracing data collection; compute monitoring collection; database monitoring collection, cloud networking criteria; geo-diversity; application programming interfaces (APIs); and/or other types of performance metrics.

Referring to FIG. 2A, process 200 may include ML/AI device 110 obtaining performance data of groups 205. For example, the performance data may include records and/or other forms of data that may provide relevant data points pertaining to the KPIs and the groups associated with the project.

Based on the performance data, ML/AI device 110 may generate tensor data based on the performance data 207. For example, according to an exemplary embodiment, ML/AI device 110 may generate a two dimensional tensor X that represents the performance data of the groups. According to other exemplary scenarios, the dimensionality of the tensor may be greater than two (e.g., three, four, or more). ML/AI device 110 may generate a vector V=[vᵢ], where i ∈ [0 . . . n] based on the two dimensional tensor X. For example, ML/AI device 110 may convert the two dimensional tensor X to a one dimensional vector V having a length of n elements. ML/AI device 110 may normalize 212 each value in vector V to a given numerical range, such as vᵢ ∈ [0,1], where i ∈ [0 . . . n].

Referring to FIG. 2B, ML/AI device 110 may calculate distances between elements of vector Vas distances dᵢⱼ that forms a set D=[d_{i,j}], where d_{i,j}=distance (vᵢ, vⱼ). For example, ML/AI device 110 may calculate a Euclidean distance, a cosine distance, or a similar type of distance. Thereafter, ML/AI device 110 may fuzzy the set D, based on a time t, to make the distances d closer in time to one another, and generate similarity data 215. For example, ML/AJ device 110 may generate a similarity matrix S according to the exemplary expression:

$${s}_{i , j} ← {\sum }_{i = 0}^{n - 1} {d}_{i , j} ( 1 - h ( {t}_{i} - {t}_{0} ) ) \qquad ( 1 )$$

in which h is a historical fuzzy value and the similarity matrix S=[sᵢ,j]. The value of h may be assigned a value between 0<h<1. According to an exemplary implementation, h=0.2, for example.

Referring to FIG. 2C, according to an exemplary embodiment, ML/AI device 110 may apply the similarity matrix S to an affinity propagation calculation according to the following exemplary expressions. For purposes of description, affinity propagation may use “communication” between data points to find exemplars for each data point. Data points that may share the same exemplars may be assigned to the same cluster. Typically, affinity propagation uses similarity data (e.g., similarity matrix), responsibility data (e.g., responsibility matrix), availability data (e.g., availability matrix), and criterion data (e.g., criterion matrix). While details of affinity propagation is beyond the scope of this description, briefly, the similarity matrix may indicate (pair-wise) similarities reflecting how similar data points are. The diagonal of the matrix may indicate a k exemplary and the non-diagonal values may contain the similarity values. The responsibility matrix may include values that reflect how responsible one data point is for another data point. The availability matrix may include values that reflect how available one data point is to be an exemplar to another data point. The iterative updating of the responsibility and availability matrices may be terminated after a fixed number of iterations associated with message-passing steps and/or after another criterion is satisfied that may indicate convergence. ML/AJ device 110 may calculate each entry of the criterion matrix based on adding the respective entries of the availability and responsibility matrices.

As a part of the affinity propagation calculation for example, ML/AI device 110 may initialize availability data 220. For example, ML/AI device 110 may initialize an availability matrix A, in which A=[a_{i,j}]=0, and where i,j ∈ [0 . . . n].

ML/AI device 110 may calculate responsibility data based on similarity data 225. For example, ML/AI device 110 may calculate a responsibility matrix R, in which R=[r_{i,j}], and where i,j ∈ [0 . . . n] according to the following exemplary expression:

$${r}_{i , k} ← {s}_{i , k} - {max}_{k ′ \neq k} \{ a ( i , {k}^{′} ) + s ( i , {k}^{′} ) \} \qquad ( 2 )$$

ML/AI device 110 may update the availability data based on the responsibility data 230. For example, ML/AI device 110 may update the availability matrix A=[a_{i,j}] based on the following exemplary expression:

$$\begin{matrix}{a}_{i , k} ← min ( 0 , & {r}_{k , k} + {\sum }_{{i}^{′} \neq \{ i , k \}} max ( 0 , {r}_{i , k} ) )\end{matrix} \qquad ( 3 )$$

$$and$$

$${a}_{k , k} ← {\sum }_{i ′ \neq k} max ( 0 , {r}_{{i}^{′} , k} )$$

Referring to FIG. 2D, ML/AI device 110 may calculate criterion data based on the availability and responsibility data 240. For example, ML/AI device 110 may calculate a criterion matrix C=[c_{i,j}] based on the availability matrix A and responsibility matric R according to the following exemplary expression:

$${c}_{i , j} ← {r}_{i , j} + {a}_{i , j} \qquad ( 4 )$$

ML/AI device 110 may identify clusters 245 in which each cluster may represent performance data of groups with similar performance data values. ML/AI device 110 may store the similar clustered data. For example, ML/AI device 110 may store a group similarity matrix T=[tᵢ,], where i ∈ [1, k] and tᵢ, may be an array including all groups of the same cluster.

Referring to FIG. 2E, ML/AI device 110 may predict future performance data 250. According to an exemplary embodiment, ML/AI device 110 may evaluate and select a group that may have a sub-optimal KPI value associated with a KPI and that an improved KPI value is deemed achievable by the group. For example, ML/AI device 110 may identify a degree of similarity and/or dissimilarity of the performance data, a category of the KPI, the KPI, and/or the KPI value (e.g., historical, current, prospective) between the target group and other groups as a basis for selecting the sub-optimal KPI value of the group, determining that an improved KPI value is achievable, and/or calculating the target KPI value, as described herein. ML/AI device 110 may also evaluate historical, current, and/or prospective performance data of the target group and/or other groups that may pertain to other (e.g., non-target) KPIs, KPI values, performance data, etc.

According to one example, under an exemplary KPI category pertaining to data collection, the performance data of the target group may be satisfactory or optimal regarding most of the KPIs under data collection, such as a KPIs relating to logging data collection, tracing data collection, and compute monitoring collection, which may include sending data to a particular system. However, the performance data of the target group may be sub-optimal regarding a KPI pertaining to database monitoring collection, which may include sending data to one of the same systems as for logging, tracing, and/or compute monitoring. Additionally, or alternatively, according to an exemplary scenario, the performance data of one or more other groups may have similar performance data relative to logging, tracing, and compute monitoring and the target group, but better performance data relative to database monitoring collection and the target group. According to another exemplary scenario, the performance data of one or more other groups may have similar performance data relative to logging and tracing, better performance data relative to database monitoring collection, but poorer performance data relative to compute monitoring and the target group.

As illustrated in FIG. 2E, ML/AI device 110 may calculate future performance data based on calculating a value in the same cluster according to the following exemplary expression:

$${k}_{i , j}^{′} = min {p}_{x , j} \qquad ( 5 )$$

in which x i and k and p are in the same cluster associated with the group similarity matrix T. The value k′indicates the predicted performance data value, such as a target KPI value for a deficient group k of a KPI, for a given future time period. ML/AI device 110 may calculate an allotted time period 260. For example, the value min p may be used as a target KPI value for the group k to achieve during an allotted future time period v. The future time period v may be defined as a certain number of days, weeks, months, or the like. According to various exemplary embodiments, the future time period v may be a static or default value or the value that may be calculated. For example, ML/AI device 110 may calculate time period v based on historical and current performance data (e.g., non-target KPIs and KPI values, target KPI and target KPI value(s), etc.) relating to the deficient group k, performance data pertaining to other similar groups, the target KPI and the underlying scoring values that may be associated with the target KPI, resources used to attain optimal or improve a current KPI value, and so forth.

According to some exemplary embodiments, ML/AI device 110 may compare the current KPI value of group k to the value min p and may adjust the future time period v based on the comparison. For example, depending on the difference between the min p value and the current KPI value of group k, more or less time may be allotted for improvement with the KPI associated with the project results.

ML/AI device 110 may calculate future performance data and time periods, which may relate to any of the KPIs, for any group associated with the project. Referring to FIG. 2F, ML/AI device 110 may generate a corrective recommendation 270. For example, based on the criteria and scoring of the target KPI, ML/AI device 110 may evaluate and provide a recommendation regarding an underlying deficiency of group k, which may be corrected to improve the target KPI and achieve the target KPI value by the allotted time period v. According to one example, the corrective recommendation may relate to a particular technology or resource, which may be available to group k for use to elevate its current KPI value. By way of further example, regarding the data collection scenario described herein, the recommendation may indicate that for other data collection, group k use a system X to send its collected or monitored data. Given that the same system X may be used to send its database collection data, ML/AI device 110 may recommend that group k incorporate the use of system X in its database collection.

The user of the ML/AI device 110 or another person associated with the project (e.g., a leader of the target group, etc.) may make managerial decisions regarding the project and the target group based on the target KPI value, the time period v, and the corrective recommendation. As a result, the progress and results that may occur during the project may be improved. ML/AI device 110 may learn and improve in calculating various values and recommendations, as described herein, over the course of the project, based on subsequent obtained performance data and historical information (e.g., performance data, historical target KPI values, etc.).

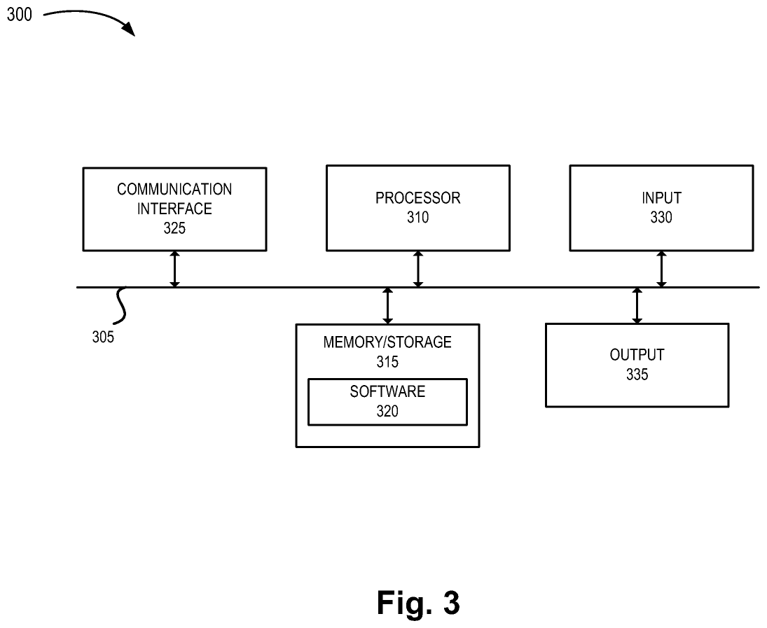

FIG. 3 is a diagram illustrating exemplary components of a device 300 that may be included in one or more of the devices described herein. For example, device 300 may correspond to ML/AI device 110, end device 115, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 315 may store data, software, and/or instructions related to the operation of device 300.

Software 320 includes an application or a program that provides a function and/or a process. As an example, with reference to ML/AI device 110, software 320 may include an application that, when executed by processor 310, provides a function and/or a process of machine learning-based project evaluation, prediction, and recommendation service, as described herein. Additionally, with reference to end device 115, software 320 may include an application that, when executed by processor 310, provides a function and/or a process of machine learning-based project evaluation, prediction, and recommendation service, as described herein. Software 320 may also include firmware, middleware, microcode, hardware description language (HDL), and/or another form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces and/or wired interfaces. For example, communication interface 325 may include one or multiple transmitters and receivers, or transceivers. Communication interface 325 may operate according to a protocol stack and a communication standard. Communication interface 325 may include various processing logic or circuitry (e.g., multiplexing/de-multiplexing, filtering, amplifying, converting, error correction, application programming interface (API), etc.). Communication interface 325 may be implemented as a point-to-point interface, a service-based interface, or a reference interface, for example.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 300 may be implemented in the same manner. For example, device 300 may be instantiated, created, deleted, or some other operational state during its life-cycle (e.g., refreshed, paused, suspended, rebooting, or another type of state or status), using well-known virtualization technologies.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function or a process described herein. Alternatively, for example, according to other implementations, device 300 may be configured to perform a function or a process described herein based on the execution of hardware (processor 310, etc.).

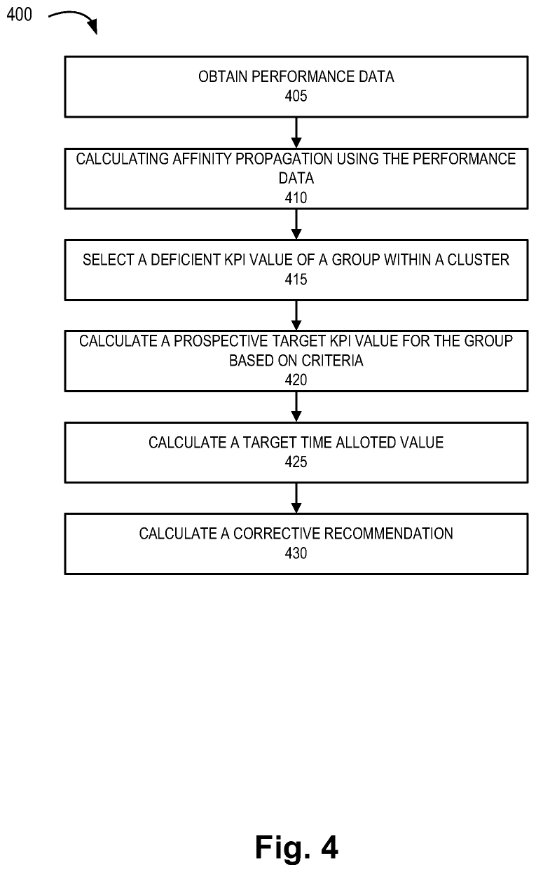

FIG. 4 is a flow diagram illustrating an exemplary process 400 of an exemplary embodiment of machine learning-based project evaluation, prediction, and recommendation service. According to an exemplary embodiment, ML/AI device 110 may perform a step of process 400. According to another exemplary embodiment, end device 115 may perform a step of process 400. According to other exemplary embodiments, a step of process 400 may be cooperatively performed by ML/AI device 110 and end device 115. According to an exemplary implementation, processor 310 may execute software 320 to perform the step of process 400, as described herein. Alternatively, the step may be performed by execution of only hardware.

For purposes of description, process 400 is described as performed by ML/AI device 110. In block 405, ML/AI device 110 may obtain performance data. For example, ML/AI device 110 may obtain performance data, such as records and/or other forms of data that may provide relevant data points pertaining to KPIs and the groups associated with the project, as described herein. ML/AI device 110 may perform some pre-processing of the performance data before calculation of affinity propagation, as described herein.

In block 410, ML/AI device 110 may calculate affinity propagation using the performance data. For example, ML/AI device 110 may perform calculations based on different matrices (e.g., availability, responsibility, etc.), the exemplary expressions, and description, as provided herein.

In block 415, ML/AI device 110 may select a deficient KPI value of a group within a cluster. For example, ML/AI device 110 may select the deficient KPI value of the group based on various criteria, as described herein.

In block 420, ML/AI device 110 may calculate a prospective target KPI value for the group based on criteria, as described herein.

In block 425, ML/AI device 110 may calculate a target time allotted value, as described herein. In block 430, ML/AI device 110 may calculate a corrective recommendation, as described herein.

FIG. 4 illustrates an exemplary embodiment of a process of machine learning-based project evaluation, prediction, and recommendation service, according to other exemplary embodiments, the machine learning-based project evaluation, prediction, and recommendation service may perform additional operations, fewer operations, and/or different operations than those illustrated and described. For example, ML/AI device 110 may provide the target KPI value, the target time allotted value, and the corrective recommendation to a user or other person of relevance.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
obtaining, by a device, performance data that indicates a state of a project based on key performance indicators (KPIs);
calculating, by the device, affinity propagation using the performance data;
selecting, by the device, a first current KPI value pertaining to one of the KPIs and a first group of the project within a cluster of the affinity propagation calculation that includes a corresponding second current KPI value pertaining to the one of the KPIs and a second group of the project, wherein the first current KPI value is less than the second current KPI value;
calculating, by the device, a prospective target KPI value pertaining to the one of the KPIs and the first group based on the second current KPI value;
calculating, by the device, a target time allotted value for the prospective target KPI value to be attained; and
providing, by the device to a user, the prospective target KPI value and the target time allotted value.

2. The method of claim 1, wherein the selecting comprises:
comparing, by the device, the first current KPI value to a threshold KPI value pertaining to the one of the KPIs; and
determining, by the device based on a result of the comparing, that the first current KPI value is deficient.

3. The method of claim 1, wherein the calculating of the target time allotted value is based on a difference value between the first current KPI value and the prospective target KPI value.

4. The method of claim 1, wherein the calculating of the prospective target KPI value is based on a category of the one of the KPIs and third current KPI values pertaining to other KPIs of the category and the second group.

5. The method of claim 1, wherein the calculating of the target time allotted value is based on a third current KPI value pertaining to another one of the KPIs and the first group.

6. The method of claim 1, wherein the device comprises a machine learning device.

7. The method of claim 1, further comprising:
calculating, by the device based on the one of the KPIs, a corrective recommendation that indicates resources to be provided to attain the prospective target KPI value.

8. The method of claim 1, wherein the KPIs pertain to development of software or a device.

9. A device comprising:
a processor configured to:
obtain performance data that indicates a state of a project based on key performance indicators (KPIs);
calculate affinity propagation using the performance data;
select a first current KPI value pertaining to one of the KPIs and a first group of the project within a cluster of the affinity propagation calculation that includes a corresponding second current KPI value pertaining to the one of the KPIs and a second group of the project, wherein the first current KPI value is less than the second current KPI value;
calculate a prospective target KPI value pertaining to the one of the KPIs and the first group based on the second current KPI value;
calculate a target time allotted value for the prospective target KPI value to be attained; and
provide to a user, the prospective target KPI value and the target time allotted value.

10. The device of claim 9, wherein, when selecting, the processor is further configured to:
compare the first current KPI value to a threshold KPI value pertaining to the one of the KPIs; and
determine, based on a result of the comparison, that the first current KPI value is deficient.

11. The device of claim 9, wherein the calculation of the target time allotted value is based on a difference value between the first current KPI value and the prospective target KPI value.

12. The device of claim 9, wherein the calculation of the prospective target KPI value is based on a category of the one of the KPIs and third current KPI values pertaining to other KPIs of the category and the second group.

13. The device of claim 9, wherein the calculation of the target time allotted value is based on a third current KPI value pertaining to another one of the KPIs and the first group.

14. The device of claim 9, wherein the device comprises a machine learning device.

15. The device of claim 9, wherein the processor is further configured to:
calculate, based on the one of the KPIs, a corrective recommendation that indicates resources to be provided to attain the prospective target KPI value.

16. The device of claim 9, wherein the KPIs pertain to development of software or a device.

17. A non-transitory computer-readable storage medium storing instructions executable by a processor of a device, wherein the instructions are configured to:
obtain performance data that indicates a state of a project based on key performance indicators (KPIs);
calculate affinity propagation using the performance data;
select a first current KPI value pertaining to one of the KPIs and a first group of the project within a cluster of the affinity propagation calculation that includes a corresponding second current KPI value pertaining to the one of the KPIs and a second group of the project, wherein the first current KPI value is less than the second current KPI value;
calculate a prospective target KPI value pertaining to the one of the KPIs and the first group based on the second current KPI value;
calculate a target time allotted value for the prospective target KPI value to be attained; and
provide to a user, the prospective target KPI value and the target time allotted value.

18. The non-transitory computer-readable storage medium of claim 17, wherein the instructions to calculate the prospective target KPI value are configured to calculate the prospective target KPI value based on a category of the one of the KPIs and third current KPI values pertaining to other KPIs of the category and the second group.

19. The non-transitory computer-readable storage medium of claim 17, wherein the instructions to calculate the target time allotted value are configured to calculate the target time allotted value based on a third current KPI value pertaining to another one of the KPIs and the first group.

20. The non-transitory computer-readable storage medium of claim 17, wherein the KPIs pertain to development of software or a device.
